(19) United States
(12) Patent Application Publication
(10) Pub. No.: US 2024/0208181 A1
(43) Pub. Date: Jun. 27, 2024

(54) COMPOSITE POLYMER STRUCTURE HAVING AN ALUMINUM POLYMER ANCHORING LAYER, AND ETCHING METHOD

(71) Applicant: Christian-Albrechts-Universitaet zu Kiel, Kiel (DE)

(72) Inventors: Mark-Daniel Gerngross, Reutlingen (DE); Melike Baytekin-Gerngross, Reutlingen (DE); Juergen Carstensen, Kiel (DE); Rainer Adelung, Kiel (DE)

(21) Appl. No.: 18/288,698

(22) PCT Filed: Mar. 13, 2022
(86) PCT No.: PCT/DE2022/100201

§ 371 Date: Oct. 27, 2023

(30) Foreign Application Priority Data
Apr. 29, 2021 (DE) 10 2021 111 149.8

(51) Int. Cl. B32B 15/08; B32B 3/30; B32B 7/02; B32B 15/04; B32B 15/18; B32B 15/20; C25F 3/04

(52) U.S. Cl. CPC B32B 15/08; B32B 3/30; B32B 7/02; B32B 15/043; B32B 15/18; B32B 15/20; C25F 3/04; B32B 2250/03; B32B 2307/7376

(57) ABSTRACT

A steel-polymer composite structure having an aluminum polymer anchoring layer, wherein the composite structure consists of—a first sub-structure which consists solely of steel,—a second sub-structure which consists solely of aluminum or an aluminum alloy and which adjoins at least sub-regions of the first sub-structure and is applied thereon, and—a third sub-structure which consists solely of a polymer, fiber-polymer composite, or polymer particle composite and which adjoins at least sub-regions of the second sub-structure and is applied thereon, wherein—a layer structure which runs from the center of the first sub-structure at least in one direction is made of the first, second, and third sub-structure such that the first sub-structure made of steel is at least partly covered by and/or is connected to the second sub-structure made of aluminum or an aluminum alloy, and the second sub-structure is at least partly covered by and/or is connected to the third sub-structure. The invention additionally relates to a method for etching anchoring structures.

The invention relates generally to a steel-polymer composite structure having an aluminum-polymer anchoring layer and to a method for etching the surface of aluminum-coated metals, and/or, more particularly, of aluminized steels.

The invention relates to a steel-polymer composite structure having an aluminum polymer anchoring layer, wherein the composite structure consists of
a first substructure consisting solely of steel,
a second substructure consisting solely of aluminum or an aluminum alloy and adjoining at least partial regions of the first substructure and is applied thereto and
a third substructure consisting solely of a polymer or polymer fiber composite or polymer particle composite, at least adjoining partial regions of the second substructure and applied thereto
wherein
a layered structure of first, second and third substructures extending from the center of the first substructure at least in one direction is formed, so that the first substructure of steel is at least partially covered by and/or bonded to the second substructure of aluminum or an aluminum alloy, and the second substructure is at least partially covered by and/or bonded to the third sub-structure.

Further, the invention relates to an method for etching anchoring structures with undercuts and/or enclosed islands of aluminum or aluminum alloys in a workpiece coating of aluminum or aluminum alloys or in a surface of aluminum or aluminum alloys of a workpiece or a steel-polymer composite structure comprising an aluminum-polymer anchoring layer.

Typically, adhesion on steels is increased by mechanical processes such as sandblasting, milling and the like, whereby a surface enlargement of the substrate is produced by these processes. In addition, chemical etching processes also exist for surface enlargement, which actually oxidize steel surfaces more easily, ultimately leading to the known disadvantages of oxides. In any case, such etching processes do not lead to an undercut structure in the steels discussed here.

Another way of improvement is to coat the steel surfaces with metal layers. Metals susceptible to corrosion, in particular iron and structural steels, are usually coated with a rapidly oxidizing and thus chemically passivating protective layer of aluminum or an aluminum alloy. Such a protective layer can, for example, be electrodeposited onto the metals. For metals with a high melting temperature, immersion in an aluminum melt is also usually a faster and less expensive method of producing a coating.

In hot-dip aluminizing, a silicon-containing aluminum alloy with, for example, or typically 8-11% silicon mass fraction is usually used as a coating. Common coating thicknesses for structural steels are around 80-150 g/m², i.e. the coatings are usually a few 10 micrometers thick.

One of the known disadvantages of an aluminum coating of metals is that adhesion of polymers, especially paints, is very poor, so that mechanical stress often leads to adhesion failure and large-area detachment of the polymer coating.

It can be seen from JP S 54 158 480 A that an electrochemical etching attack on the aluminum coating of a steel substrate is suitable for roughening the surface of the coating and introducing recesses into the coating in which a fluoropolymer applied after this is better held. Although the publication refers to an “an-choring effect,” there is no indication that the etched recesses would have undercuts or other retaining structures that could be enclosed by the fluoropolymer in an initially flowable state and retained after curing of the polymer. Rather, the recesses appear to run in a straight line from the surface into the coating, which is shown, for example, in FIG. of the publication and also corresponds to the description of this publication “fine unevenness”. However, such recesses are not etched anchoring structures in the sense of this description, because one could pull the cured polymer out of the recesses without damaging it.

For the definition of anchoring structures in aluminum or aluminum alloys after an etching treatment, reference is made to the following sources and the cited figures in those sources, as well as to the figures of the present disclosure.

It is also known from the prior art, for example from U.S. Pat. No. 2,944,917 B1, that the adhesion of polymers, especially those with low surface energy such as silicone or polytetrafluoroethylene (PTFE), to surfaces made of aluminum and aluminum alloys can be significantly improved by treating the metal for a few minutes with concentrated hydrochloric acid at room temperature. This results in the formation of pore structures in the metal that exhibit undercuts and angulations. If a polymer in flowable form is brought into contact with the surface etched in this way and solidified, e.g. as in U.S. Pat. No. 2,944,917 B1 an aqueous suspension of PTFE particles which are thermally fused after evaporation of the water, the polymer can no longer be removed from the metal even with great force.

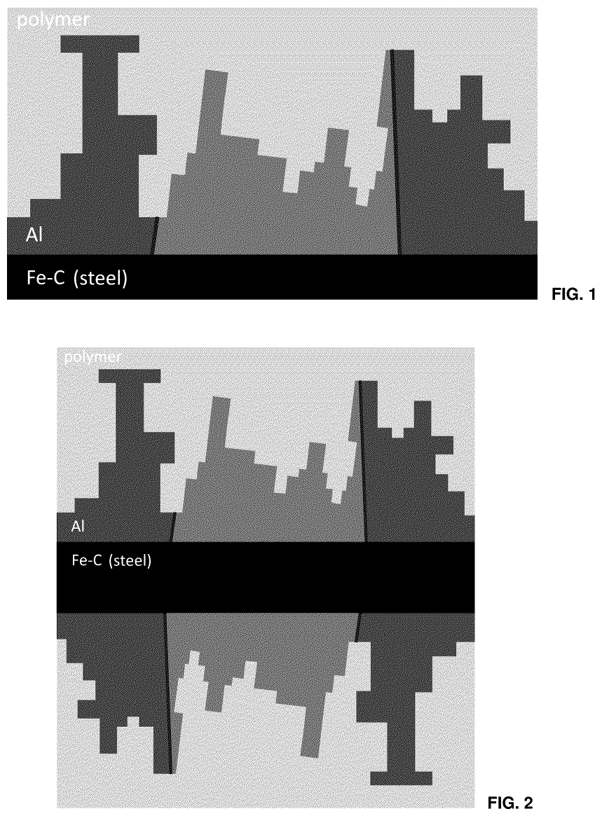

For example, from Jin Yang et al. “Superoleophobic textured aluminum surfaces,” New J. Chem., 2011, 35, 2422-2426, images of the surface of pure aluminum after an etching attack with hydrochloric acid can be seen in FIGS. 6a and b shown there. Further example images of etched aluminum surfaces with anchoring structures are shown in FIG. 1 in US 2013/0264196 A1, which, however, does not deal with mechanical anchoring but with the surface enlargement of aluminum anodes in electrolytic capacitors, and therefore etches particularly deep pores electrochemically. These pores would penetrate the applied Al layer and destroy the corrosion protection of the Al layer. In addition, hydrogen embrittlement of the underlying steel substrate can occur there.

DE 10 2016 113 641 A1 discloses a heterostructure comprising at least a first partial surface comprising copper alone and at least a second partial surface opposite to the first partial surface comprising aluminum or an aluminum alloy alone, wherein a. an anchoring layer is arranged between the first and second partial surfaces, wherein b. each intersection surface extending perpendicularly to the anchoring layer comprises at least one island of aluminum or aluminum alloy surrounded by copper, and c. at most the previously known mixed crystals of the aluminum alloy occur in the anchoring layer. Furthermore, the invention relates to an aluminum-copper connector and a heterostructure fabrication process.

In addition, DE 23 20 099 A shows a process for producing a plastic substrate with a roughened surface by laminating an aluminum foil with a rough surface to a plastic substrate under heating and pressure and then chemically etching off the aluminum foil. In particular, the invention relates to a process for producing plastic substrates having roughened surfaces of such a kind that they are capable of firmly anchoring thin metal layers or layers applied as inks, inks or paints without current.

In addition, the state of the art includes non-wet-chemical, but physically produced structuring by means of plasma and laser, which, however, cannot generate undercut structures in the aluminum surface layer, but rather chemically activate the surface (plasma) or remelt it close to the surface, leaving small melt burrs (laser) on the surface.

The state of the art of mechanical surface processes and chemical processes leading to an increase in surface area results in some increase in polymer adhesion, but still leads to adhesive failure/delamination under mechanical load due to the still low polymer adhesion. This can only be partially compensated by the use of high concentrations of adhesion promoters. In addition, the problem of adhesion base alteration due to changes in the oxides of the steel substrate under environmental conditions remains unsolved for these processes, as does the issue of crevice corrosion.

In the prior art chemical processes, hydrogen embrittlement is an additional negative effect. Hydrogen embrittlement is a glaring disadvantage, particularly in the case of steel-polymer composites subjected to high mechanical loads, as it can in some cases reduce the mechanical properties of the steel to such an extent that they can fail or lead to cracks/fractures even under low static or dynamic mechanical loads. In principle, hydrogen embrittlement is bad for the reliability of such steel/polymer composites, as it can also cause the composite to fail close to the surface within the steel component.

Plasma- or laser-structured steel surfaces do not have any undercut structures in the surface, but at most lead to increased surface roughness (laser through melt burrs). Therefore, adhesive failure also occurs here due to the lack of undercut structures.

The problem with steels is that polymers often adhere rather poorly to very poorly to steels because of the large number of oxides and the changing oxides under environmental conditions. This phenomenon of oxide problems leads to a change in the adhesion basis of the polymers. Previous steel-polymer composites suffer from two typical problems:
1. delamination or adhesive failure at the steel-polymer interface under mechanical load (e.g., tension or compression), and
2. changing adhesion to the steel substrate due to environmental conditions (transformation of the oxides).

The aim of the invention disclosed herein is to improve steel-polymer composites. These composites have a very wide range of applications, from simple two-layer systems through multilayer systems to, for example, wire mesh composites or coated individual wires/tapes. As already explained, the aluminum layer applied to the steel substrate in the prior art acts as corrosion protection for the steel substrate. After treatment of the surface according to the invention, i.e. in particular after a nanoscale-sculpturing process, this layer should or can also act as a mechanical adhesion promoter via “mechanical interlocking”. On the subject of undercut structures in the metal component via “mechanical interlocking”, reference is made to “Nanoscale sculpturing of metals and its applications, Making metal surfaces strong, resistant, and multifunctional by nanoscale-sculpturing”, Nanoscale Horizons 1(6):467-472, DOI: 10.1039/C6NH00140H, Baytekin Gerngross as well as the papers and literature cited in this publication.

The task of the invention can further be seen in enabling the production of steel-polymer composites in which there is no adhesive failure between steel and polymer due to the undercut structures in the Al/Al alloy surface firmly adhering to the steel surface. A key constraint here is that no hydrogen embrittlement should occur and no closed oxide layers are produced.

The task or tasks are solved with a steel-polymer composite structure according to the main claim and can be further solved by an etching process according to the subsidiary claim.

The steel-polymer composite structure having an aluminum polymer anchoring layer, wherein the composite structure consists of
a first substructure consisting solely of steel,
a second substructure consisting solely of aluminum or an aluminum alloy and adjoining at least partial regions of the first substructure and is applied thereto and
a third substructure consisting solely of a polymer or polymer fiber composite or polymer particle composite, at least adjoining partial regions of the second substructure and applied thereto
wherein
a layered structure of first, second and third substructures extending from the center of the first substructure at least in one direction is formed, so that the first substructure of steel is at least partially covered by and/or bonded to the second substructure of aluminum or an aluminum alloy, and the second substructure is at least partially covered by and/or bonded to the third sub-structure,
characterized in that
the thickness of the first substructure is greater than and/or equal to that of the second sub-structure
an anchoring layer directly connects the second and third substructures to one another, the anchoring layer having anchoring structures with undercuts and/or enclosed islands of aluminum or aluminum alloy which are surrounded and/or enclosed and/or filled by material of the third substructure which is still in the liquid state during production, and
the islands and/or undercuts which are surrounded and/or enclosed and/or filled have
a cuboidal and/or nested cuboidal shape and
a minimum size of 200 nm
and
sharp and/or rounded edges.

The thickness of the anchoring layer can in particular be between 0.5 and 100 micrometers, or particularly preferably between 10 and 50 micrometers. This represents a thoroughly also preferred further relevant feature of the invention, since the one anchoring layer according to the invention, the thickness of which is in particular between 10 and 50 micrometers, or even already in the range of 0.5 to 100 micrometers, has significantly higher maximum roughness. According to the invention, the anchoring layer connects the second and third substructures to one another, the anchoring layer having anchoring structures with undercuts and/or enclosed islands of aluminum or aluminum alloys, which are formed to be flowed around and/or enclosed and/or filled by material of the third substructure which is still in the liquid state during manufacture. The islands and/or undercuts which are surrounded and/or enclosed and/or filled have a cuboidal and/or nested cuboidal shape, a minimum size of 200 nanometers and sharp and/or rounded edges.

A preferred embodiment of the steel-polymer composite structure is present with the following combination of features:

The steel-polymer composite structure having an aluminum polymer anchoring layer, wherein the composite structure consists of
a first substructure consisting solely of steel,
a second substructure consisting solely of aluminum or an aluminum alloy and adjoining at least partial regions of the first substructure and is applied thereto
and
a third substructure consisting solely of a polymer or polymer fiber composite or polymer particle composite, at least adjoining partial regions of the second substructure and applied thereto
wherein
a layered structure of first, second and third substructures extending from the center of the first substructure at least in one direction is formed, so that the first substructure of steel is at least partially covered by and/or bonded to the second substructure of aluminum or an aluminum alloy, and the second substructure is at least partially covered by and/or bonded to the third sub-structure, and is characterized in that
the thickness of the first substructure is greater than and/or equal to that of the second sub-structure
and
an anchoring layer directly connects the second and third substructures to one another, the anchoring layer having anchoring structures with undercuts and/or enclosed islands of aluminum or aluminum alloy which are surrounded and/or enclosed and/or filled by material of the third substructure which is still in the liquid state during production,
the thickness of the anchoring layer is between 10 and 50 micrometers
and
the islands and/or undercuts which are surrounded and/or enclosed and/or filled have
a cuboidal and/or nested cuboidal shape
and
a minimum size of 200 nm
and
sharp and/or rounded edges.

Further, the steel-polymer composite structure may be formed such that
any cut surface running perpendicular to the anchoring layer in the region of the anchoring structure has at least one island of polymer or polymer fiber composite or polymer particle composite enclosed by aluminum or aluminum alloy,
and/or
any cut surface running perpendicular to the anchoring layer has, in the region of the anchoring structure, at least one island of aluminum or aluminum alloy enclosed by polymer or polymer fiber composite or polymer particle composite.

Further, particularly preferably, at most the aforementioned solid solutions including the intermetallic phases of the aluminum alloy can occur in the anchoring layer.

Exemplarily or also in particular, but in particular in at least one concrete embodiment, the method for etching, according to the invention, for anchoring structures with undercuts and/or enclosed islands of aluminum or aluminum alloys in a workpiece coating of aluminum or aluminum alloys or in a surface of aluminum or aluminum alloys of a workpiece or a steel-polymer composite structure comprising an aluminum-polymer anchoring layer can be characterized in that the etching is performed
by means of electrochemical etching of the surface in an etching bath, wherein the workpiece coating or the surface of the workpiece is used as the working electrode for the etching and this surface of the working electrode is arranged opposite a counter electrode in the etching bath;
with an aqueous electrolyte solution having a low chlorine ion concentration of less than 0.8 mmol/cm³, the electrolyte being provided as an aqueous solution of a chlorine salt;
with an average etching current density greater than 1 A/cm²;
at a temperature in the range from 1° C. to 40° C. and
in a time of less than 60 seconds.

Further, in particular embodiments, the electrolyte may be provided as an aqueous solution of a chlorine salt, wherein in particular one of sodium chloride or potassium chloride or calcium chloride is provided to provide the chlorine ion concentration.

Another advantage of using salt water electrolytes, especially instead of concentrated acid mixtures, is the unproblematic disposal of the electrolyte.

Specifically, the workpiece may be formed of a corrosive metal, particularly steel, and the coating or surface is an anti-corrosion coating, wherein the corrosive metal, i.e., the steel is not etched.

The process disclosed here is much less expensive to carry out and faster, since strongly oxidizing acids can be dispensed with.

Surprisingly, the inventors also found out that the quasi unbraked etching according to the invention with high flow rates, typically more than 10 ltr/min per cm² cross-section through which the electrolyte flows, and high current densities, can suppress the passivation by adsorption of chloride ions on the surface and thus particularly positive results can be achieved. The article according to the invention differs in a special way from the prior art in particular in that undercut structures are formed on the surface-structured aluminum surface or aluminum alloy surface by electrochemical structuring, which are then enclosed by a flowable polymer (thermosetting, curing at RT or solidifying [thermoplastic]).

Furthermore, it is also particularly inventive and new that the high-strength steel-aluminum polymer composite per se or the electrochemical structuring process for the Al/Al alloy surface firmly adhering to the steel surface can be produced with the formation of undercut structures, i.e. in particular cuboid structures, without hydrogen embrittlement occurring in the steel component or a buildup of thick oxide layers (such as those formed during anodizing).

The process claimed here differs from the prior art in particular in the etching current density and the etching time. In the present etching process, the average etching current density is greater than 1 A/cm². In known etching processes, etching is performed at an etching current density in the range from 10 mA/cm² to 100 mA/cm², so that etching current densities used in the prior art are thus one to two powers of ten lower than the etching current density used in the process according to the present invention.

The etching time according to the present etching process is less than 60 seconds. In the prior art, the etching time is, among other things, 30 minutes. In addition, the prior art also explicitly discloses that etching is uniformly slow everywhere. Therefore, the etching durations disclosed in the prior art are thus completely contrary to the etching duration of the present etching process.

Also, the electrolyte according to the present disclosure is formed as an aqueous solution of a chlorine salt. Electrolyte according to the prior art is provided, for example, as a mixture of several salts, for example, as an aqueous solution of sodium chloride and sodium sulfate.

According to the state of the art, etching is performed at an etching current density in the range of 10 mA/cm² to 100 mA/cm² (cf. the state of the art discussed in the introduction). If the etching current density is too high, diffusion limitation of the passivation species sets in. For example, US 2013/0264196 A1 states that etching occurs at an etching current density of 100 to 1000 mA/cm² and diffusion limitation of the passivation species occurs. Therefore, from the prior art, high etching current densities with aqueous electrolytes in the order of magnitude of the etching process disclosed on this side are not stimulated or not suggested.

A slow etching is in strong contrast to the etching duration of less than 60 seconds of the present process according to the invention. Etching durations in the order of magnitude of the present process cannot regularly be applied with known prior art processes, since otherwise the desired results with respect to the heterostructure cannot be achieved with the specified process parameters. In this respect, it also does not apply here that it is familiar to those skilled in the art of electrochemistry that when an etching parameter is changed, the etching time must be adapted to the new conditions. Moreover, the contrast between uniformly slow etching with a duration of, for example, 30 minutes and an etching process of less than 60 seconds is so great that this no longer represents an adjustment within the “normal framework”, but a new process.

In this process according to the invention, the electrolyte is provided as an aqueous solution of a chlorine salt. In particular, in a preferred embodiment, it may comprise at least one of sodium chloride, potassium chloride or calcium chloride. In the process according to further prior art, the electrolyte for direct electrolytic etching is preferably provided as an aqueous alkali solution, such as sodium carbonate or sodium hydroxide solution, or as an aqueous acid, such as hydrochloric acid. The etching process according to the present invention has an aqueous electrolyte with a low chlorine ion concentration of less than 0.8 mmol/cm, whereas the aqueous chlorine ion-containing electrolyte according to the prior art is provided as a 0.5 to 5% by weight aqueous hydrogen chloride or sodium chloride solution.

The use of an alkaline or acidic electrolyte solution is in complete contrast to the use of a chlorine salt according to the present invention. The electrolyte according to the present method is environmentally safe, easy to dispose of, easy to handle, and easy to produce. An acid or alkali as electrolyte, as used in the prior art, is subject to certain safety regulations which must be observed.

With known etching processes, anchoring structures with undercuts and/or enclosed islands of aluminum or aluminum alloys in a workpiece coating of aluminum or aluminum alloys or in a surface of aluminum or aluminum alloys of a workpiece or a steel-polymer composite structure are not regularly produced, wherein the flowed around and/or enclosed and/or filled islands and/or undercuts have a cuboidal and/or nested cuboidal shape and a minimum size of 200 nanometers and sharp and/or rounded edges, as would be possible according to the method according to the present invention. There are precisely no undercuts with a cuboidal and/or nested cuboidal shape.

The possible applications of the composite according to the invention can be seen in particular in the most diverse fields, such as, among others, aviation, the automotive industry, architecture (sheet metal parts coated with paint, inserts in fiber composites to increase strength), medical technology (orthopedic components coated with e.g. silicone), etc.

In a manufacturing variant, the following configuration can preferably be used procedurally to provide structured steel with Al alloy layer as a component by etching accordingly with a structuring, namely in that:
the electrochemical cell is connected with steel with Al alloy layer as anode, with the Al layer in contact with the electrolyte;
the current source can be used with a wide range of current densities, e.g. 1A/cm² for 15s, with the general relation: higher current densities lead to smaller process times at the same electrolyte concentration
active electrolyte circulation during patterning leads to further improvement of the etching result and simultaneous reduction of the etching time at high current densities;
the electrolyte temperature can typically be room temperature, although higher/lower temperatures are possible;
in particular, an electrolyte with 0.2 mol/l NaCl in water can be run to achieve the desired etching results;
the Cl-concentration can also be provided via HCl or other chlorides;
higher or lower concentrations are possible, whereby an interplay with current density and electrolyte flow rate is set and must be observed here.

The aluminized steel surfaces can be structured in particular by electrochemical etching. By means of this process, aluminized steel surfaces can be structured independently of the coating thickness of the highly aluminum-rich coating. In one embodiment in particular, the structuring can be carried out in a simple electrochemical cell consisting of a counter-electrode and the aluminized steel surface as working electrode. Very short etching times are preferable overall so as not to dissolve too much of the aluminum layer, since this also serves as a corrosion protection layer for the steel.

At least one interface between structured steel with Al alloy layer and polymer in various geometric shapes, such as flat multilayers, wires, wire meshes, ribbons, spheres, etc. can be produced in this way.

In addition, various composites can be produced, even with different polymers at the same time, e.g. layer sequence polymer1—steel with Al alloy layer—polymer2.

Coating can be carried out, for example, by dipping/spraying into initially flowable and subsequently curing polymer, e.g. thermosets & elastomers, but also thermoplastics. Resin transfer molding of composites with structured steel with Al alloy layer inserts is also possible. In addition, thermal spraying processes known in the prior art, including injection molding, powder coating, painting and the like are also possible.

Overall, various advantages result from the invention disclosed here, namely:
the production of undercut structures on steel components without hydrogen embrittlement; the cyclic strength is therefore not negatively affected; in addition, the steel structure has suitable and undestroyed corrosion protection due to the aluminum or Al alloy layer, which leads to a very high corrosion resistance;
the mechanical static as well as cyclic properties are unchanged high compared to the unstructured steel component;
there is no formation of a chemically unstable oxide layer on the steel surface or no thick oxide layer on the Al alloy surface, so that no multilayer interface between the steel component and the polymer as a “weak interface” is formed.

Furthermore, the following advantages of the structuring process result from:
a short processing time for the production of undercut structures in steel Al alloy layer;
use of salt water electrolytes instead of concentrated acid mixtures;
unproblematic disposal of the electrolyte;
no high voltages necessary, as for example in anodizing.

In addition, the following advantages result for the steel-Al alloy layer polymer composite:
no adhesive failure at the steel-polymer interface (compared to other composites produced with conventional steel surface treatment processes) due to mechanical anchoring while avoiding hydrogen embrittlement and corrosion protection by Al-alloy layer, here no occurrence of hydrogen-containing phases near the structured surface (verification: e.g. via XRD)
no Fe-oxide layer, which would lead to a chemically unstable ceramic and thus to brittle mechanical behavior under stress, ultimately to fracture in the ceramic layer, resulting in unpredictability of failure.

In the following, the invention is described with reference to the accompanying figures in the description of figures, whereby these are intended to explain the invention and are not necessarily to be regarded as limiting:

FIG. 1 shows a composite consisting of a steel-aluminum coating alloy component structured on one side and a polymer, a first surface being formed accordingly here. An interface is formed between the polymer and the structured steel-aluminum alloy component.

The general layered structure of the first substructure made of steel, followed by the second substructure made of aluminum or an aluminum alloy and the third substructure made of the polymer material can be seen here, with the second and third substructures together forming a common anchoring structure.

FIG. 2 shows a composite consisting of a structured steel-aluminum alloy component and a polymer, whereby a first and a second side or even the entire structure is formed accordingly. A multilayer system is formed here, whereby the steel-aluminum alloy component can have any shape, e.g. plate, wire, sphere, braiding and the like.

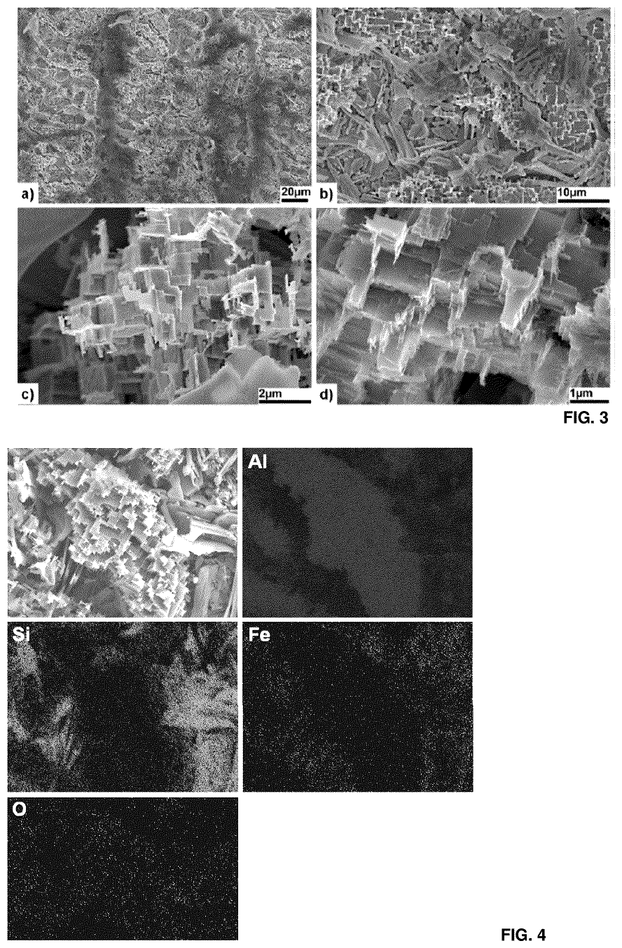

FIG. 3 shows a nanoscale sculpted hot-dip aluminized steel in a top view. The SEM images of the aluminized steel surface after sculpturing, a) macroscopic overview, b) magnification on the aluminum-silicon structures, c) partially free-standing barb structure and d) magnification of such a structure.

FIG. 3a) shows a typical section of the aluminized steel surface after structuring. It can be seen that the surface has been completely structured. Differently structured areas are already visible, which are shown in higher magnification in FIG. 3b). Two main structures can be found on the surface, which are interconnected. One type of structure is cuboidal structures arranged in staircases or in partially freestanding structures. The second type is fanning dendritic structures that are also located throughout the surface. Chemical composition analysis of these two structures is shown in FIG. 4 and described in the associated text below. FIG. 3c) is an exemplary representation of one of these million-part free-standing barbed structures composed of cuboids present on the patterned surface. It can be seen that these cuboidal structures are always oriented at right angles to each other. Individual areas can be rotated relative to each other—as can be seen in the upper right area in FIG. 3c)—depending on the crystallographic orientation of the grains near the surface. These cuboidal structures occur not only very close to the surface, but also in depth, as shown in the left part of FIG. 3c). Besides the cuboidal structures, FIG. 3c) also shows parts of the dendritic structures—see left upper and right lower part. These structures show a very smooth surface without formation of any appreciable microstructure. An enlargement of the cuboid structures is shown in FIG. 3d). The typical sizes of the cuboids range from tens of nanometers for the finest structures to the low micrometer range. The partially free-standing cuboid structures in combination with the dendritic structures also embedded in the surface form a mechanical interlocking structure. This is particularly advantageous for the mechanical bonding of polymers, other metals or even ceramics to the aluminized steel surface, as a rigid mechanical bond is formed between the two materials and the structured, aluminized steel surface as soon as the interlocking structures are enclosed by the polymer, for example.

FIG. 4 shows an EDX of nanoscale sculpted hot-dip aluminized steel in a top view. The elemental distribution of the sculpted aluminized steel surface investigated by EDX is shown. The EDX elemental distributions of the textured aluminized steel surface with distributions for aluminum, silicon, iron and oxygen. It can be seen that the cuboid structures described in FIG. 3 are aluminum, while the dendrite structures are silicon precipitates. The iron signal also shows a location dependence in the elemental distribution and is more pronounced at the locations where the Si rich dendrite structures are preferentially located. In addition, traces of oxygen are found on the structured surface in both the more Al-rich and Sirich regions on the surface. These are due to the formation of the native oxide layer on the aluminum and silicon structures.

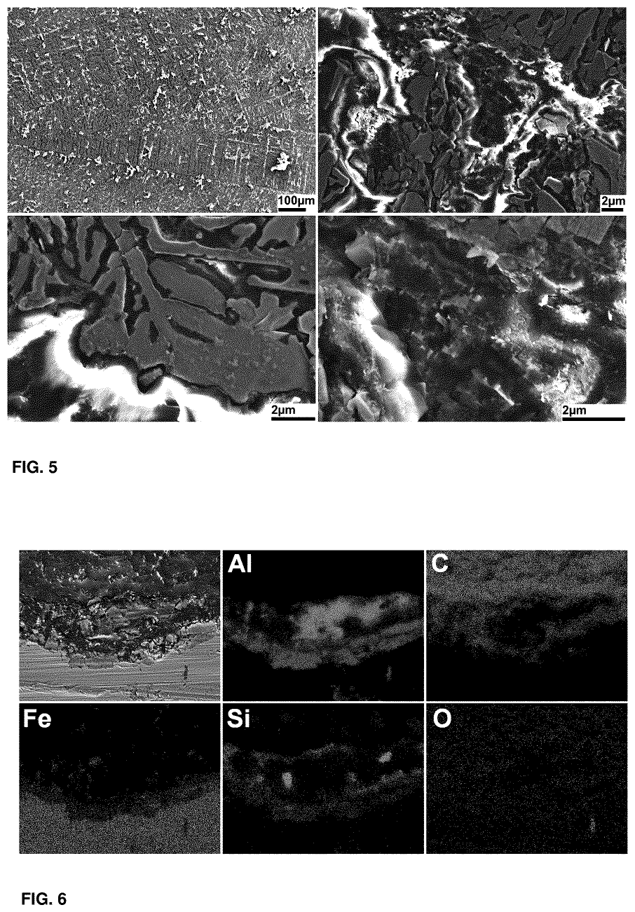

FIG. 5 shows a fracture surface of a nanoscale sculptured hot-dip aluminized steel-epoxy composite in a plan view.

FIG. 6 shows a fracture surface (top left) and EDX of a nanoscale sculpted fire aluminized steel-epoxy composite in a top view. The elemental distribution of the sculpted aluminized steel surface investigated by EDX is shown. The EDX elemental distributions of the patterned aluminized steel surface with distributions for aluminum, carbon, silicon, iron and oxygen.

1. A steel-polymer composite structure having an aluminum polymer anchoring layer, wherein the composite structure consists of
a first substructure consisting solely of steel,
a second substructure consisting solely of aluminum or an aluminum alloy and adjoining at least partial regions of the first substructure and is applied thereto and
a third substructure consisting solely of a polymer or polymer fiber composite or polymer particle composite, at least adjoining partial regions of the second substructure and applied thereto
wherein
a layered structure of first, second and third substructures extending from the center of the first substructure at least in one direction is formed, so that the first substructure of steel is at least partially covered by and/or bonded to the second substructure of aluminum or an aluminum alloy, and the second substructure is at least partially covered by and/or bonded to the third sub-structure,
wherein
the thickness of the first substructure is greater than and/or equal to that of the second sub-structure,
an anchoring layer directly connects the second and third substructures to one another, the anchoring layer having anchoring structures with undercuts and/or enclosed islands of aluminum or aluminum alloy which are surrounded and/or enclosed and/or filled by material of the third substructure which is still in the liquid state during production, and
the islands and/or undercuts which are surrounded and/or enclosed and/or filled have
a cuboidal and/or nested cuboidal shape and
a minimum size of 200 nm
and
sharp and/or rounded edges.

2. The steel-polymer composite structure according to claim 1,
wherein the thickness of the anchoring layer is between 0.5 and 100 micrometers.

3. The steel-polymer composite structure according to claim 1, wherein
any cut surface running perpendicular to the anchoring layer in the region of the anchoring structure has at least one island of polymer or polymer fiber composite or polymer particle composite enclosed by aluminum or aluminum alloy,
and/or
any cut surface running perpendicular to the anchoring layer has, in the region of the anchoring structure, at least one island of aluminum or aluminum alloy enclosed by polymer or polymer fiber composite or polymer particle composite.

4. The steel-polymer composite structure according to claim 1, wherein at most solid solutions including intermetallic phases of the aluminum alloy occur in the anchoring layer.

5. A method for etching anchoring structures with undercuts and/or enclosed islands of aluminum or aluminum alloys in a workpiece coating of aluminum or aluminum alloys or in a surface of aluminum or aluminum alloys of a workpiece or a steel-polymer composite structure comprising an aluminum-polymer anchoring layer,
wherein
the flowed around and/or enclosed and/or filled islands and/or undercuts have
have a cuboidal and/or nested cuboidal shape
and
a minimum size of 200 nm
and
sharp and/or rounded edges
whereby the etching is carried out
by means of electrochemical etching of the surface in an etching bath, wherein the workpiece coating or the surface of the workpiece is used as the working electrode for the etching and this surface of the working electrode is arranged opposite a counter electrode in the etching bath;
with an aqueous electrolyte solution having a low chlorine ion concentration of less than 0.8 mmol/cm³, the electrolyte being provided as an aqueous solution of a chlorine salt;
with an average etching current density greater than 1 A/cm²;
at a temperature in the range from 1° C. to 40° C.
and
in a time of less than 60 seconds.

6. The method for etching according to claim 5, wherein the electrolyte is provided as an aqueous solution of a chlorine salt, at least one of the salts being sodium chloride or potassium chloride or calcium chloride.

7. The method for etching according to claim 5, wherein the workpiece is formed of a corroding metal and the coating or surface is an anti-corrosion layer, wherein the corroding metal is not etched.

8. The steel-polymer composite structure according to claim 1,
wherein the thickness of the anchoring layer is between 10 and 50 micrometers.
